(19) United States
(12) Patent Application Publication
(10) Pub. No.: US 2012/0284535 A1
(43) Pub. Date: Nov. 8, 2012

(54) INFORMATION PROCESSING APPARATUS CAPABLE OF REDUCING LABOR FOR DATA MANAGEMENT OPERATION, AND DATA MANAGEMENT METHOD AND STORAGE MEDIUM THEREFOR

(75) Inventor: Hideo ASAHARA, Yokohama-shi (JP)

(73) Assignee: CANON KABUSHIKI KAISHA, Tokyo (JP)

(21) Appl. No.: 13/461,275

(22) Filed: May 1, 2012

(30) Foreign Application Priority Data
May 6, 2011 (JP) 2011-103711

(51) Int. Cl. G06F 21/24

(52) U.S. Cl. 713/193

(57) ABSTRACT

An information processing apparatus capable of reducing user's labor required for a data management operation by enabling the user to leave the data management operation to a serviceman without lowering the security of user data. User data and serviceman data both stored in a data storage unit are encrypted by an encryption unit with an encryption key generated based on information set in advance in the information processing apparatus and with an encryption key generated based on information input by a serviceman, respectively. These encrypted data are output from an export unit to an auxiliary storage unit.

### BACKGROUND OF THE INVENTION

1. Field of the Invention

The present invention relates to an information processing apparatus, and a data management method and a storage medium therefor.

2. Description of the Related Art

A lot of data such as user authentication information and address book are generally stored in an information processing apparatus, e.g., in an image processing apparatus. These data include personal information that is peculiar to a user (hereinafter referred to as the user data) and that must be prevented from being viewed by a person other than the user.

Data for use by a serviceman in conducting maintenance of the image processing apparatus (hereinafter referred to as the serviceman data) is also stored in the image processing apparatus. The serviceman data includes data that must be prevented from being viewed by a person other than the serviceman. The user data and the serviceman data are important resources for the user and the serviceman and preferably backed up regularly.

A data management operation is sometimes performed. For example, when some data is added to a particular image processing apparatus, the added data is copied and added to another image processing apparatus. Since the data management operation generally requires a lot of labor, some user is unwilling to perform the data management operation. Thus, the data management operation is sometimes left to a serviceman.

Usually, means for executing the data management operation is provided in a user-dedicated screen of the image processing apparatus and allowed to be used only by a person authenticated as an administrator user. Accordingly, in the case of asking a serviceman to execute the data management operation, the administrator user gets authentication and makes the image processing apparatus operable with administrator user authority. As a result, the serviceman becomes capable of performing all the operations that are allowed for the administrator user, which poses a problem.

To allow the serviceman to perform only the data management operation, means for executing the data management operation may be provided in a serviceman-dedicated screen. However, in that case, the serviceman becomes capable of freely handling user data without any permission by the user, so that there is a fear that the user data can be leaked, posing a security problem.

To obviate this, it is possible to allow the serviceman authenticated as an administrator user to perform the data management operation via the user-dedicated screen under permission and surveillance of the user. However, this requires the user to attend the data management operation and hence cannot reduce the labor of the user.

There has been proposed a control apparatus for a copy machine, by which an operation level is set at a low level to prevent an operator from using a serviceman tool when the operator uses a user tool, thereby enhancing the secrecy of tool information of the serviceman tool (see, for example, Japanese Laid-open Patent Publication No. H5-61284). With this operation level control, however, the serviceman becomes capable of freely handling user data whose use is not limited, so that there is a fear that the user data can be leaked. This poses a security problem.

### SUMMARY OF THE INVENTION

The present invention provides an information processing apparatus capable of reducing user's labor required for a data management operation by enabling the user to leave the data management operation to a serviceman without lowering the security of user data, and provides a data management method for the information processing apparatus and a storage medium storing a program for causing a computer to execute the data management method.

According to one aspect of this invention, there is provided an information processing apparatus comprising a storage unit configured to store user data peculiar to a user of the information processing apparatus and to store serviceman data for use by a serviceman in conducting maintenance of the information processing apparatus, an encryption unit configured to encrypt the user data with an encryption key generated based on information set in advance in the information processing apparatus and configured to encrypt the serviceman data with an encryption key generated based on information input by the serviceman, and an output unit configured to output the user data and the serviceman data both encrypted by the encryption unit.

With this invention, a user can leave the data management operation to a serviceman, whereby user's labor required for the data management operation can be reduced, while maintaining the security of user data.

Further features of the present invention will become apparent from the following description of an exemplary embodiment with reference to the attached drawings.

### BRIEF DESCRIPTION OF THE DRAWINGS

FIG. 1 is a block diagram showing the hardware structure of an image processing apparatus serving as an information processing apparatus according to one embodiment of this invention;

FIG. 2 is a block diagram showing the software structure of the image processing apparatus;

FIG. 3 is a view showing an export instruction screen displayed on a display of the image processing apparatus;

FIG. 4 is a view showing an import instruction screen displayed on the display of the image processing apparatus;

FIG. 5 is a view showing an import screen displayed on a display of an image processing apparatus according to a modification of this invention;

FIG. 6 is a flowchart showing procedures of an export process performed by the image processing apparatus according to the embodiment of this invention;

FIG. 7 is a flowchart showing procedures of an import process performed by the image processing apparatus;

FIG. 8 is a view showing a data list stored in a data storage unit of the image processing apparatus;

FIG. 9 is a view showing an example of export data generated by an export unit of the image processing apparatus; and

FIG. 10 is a view showing an example of a data storage method for the image processing apparatus.

### DESCRIPTION OF THE EMBODIMENTS

The present invention will now be described in detail below with reference to the drawings showing a preferred embodiment thereof.

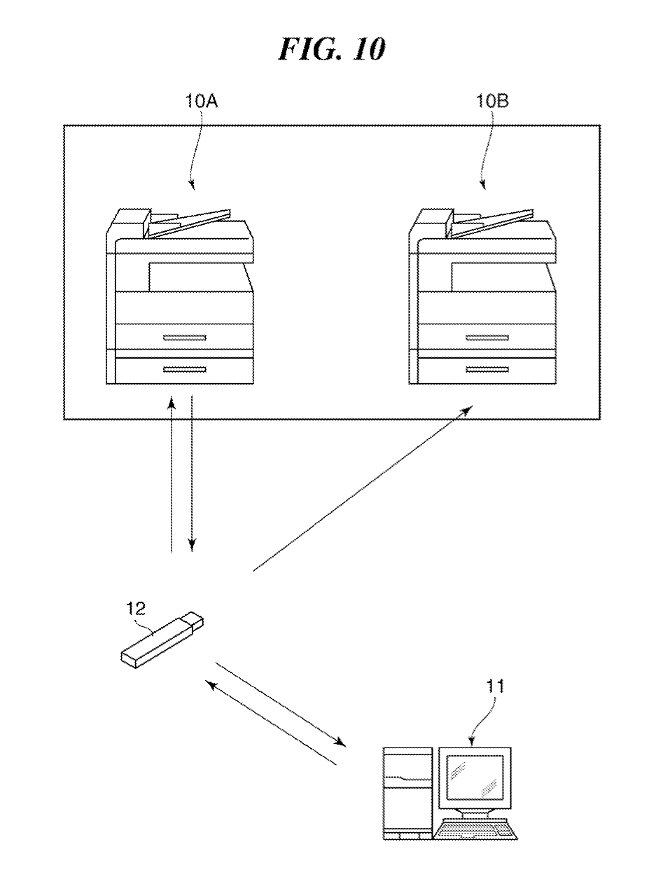

First, with reference to FIG. 10, a description will be given of an example of a data management method for an image forming apparatus as an information processing apparatus according to one embodiment of this invention.

This data management method is applied between image processing apparatuses (two of which are illustrated in FIG. 10 and respectively denoted at 10A and 10B) for use by users and a personal computer 11 for use by a serviceman. Each of the image processing apparatuses has a data storage unit in which user data peculiar to a user and serviceman data for use by a serviceman in conducting maintenance of image processing apparatuses are stored distinguishably from each other.

There is a case where a user asks a serviceman to perform maintenance of the image processing apparatus 10A and to set user data (e.g., address book) set in the image processing apparatus 10A to the image processing apparatus 10B.

In that case, the serviceman causes an export unit of the image processing apparatus 10A (as the object of maintenance) to output the user data and serviceman data necessary for management of the image processing apparatus 10A to a portable auxiliary storage unit (removable medium), e.g., a USB memory 12. At that time, an encryption unit of the image processing apparatus 10A encrypts the serviceman data and the user data such that the encrypted serviceman data can be used only by the serviceman and the encrypted user data cannot be used by a third party such as the serviceman.

Next, the serviceman detaches the USB memory 12 from the image processing apparatus 10A and connects the USB memory 12 to the personal computer 11. The serviceman data is decrypted and the decrypted serviceman data is backed up and updated or corrected. Next, the personal computer 11 encrypts the updated or corrected serviceman data in a manner capable of being decrypted by the image processing apparatus 10A, and stores the encrypted data into the USB memory 12.

It should be noted that since the serviceman data cannot be decoded by a third party, the secrecy of the serviceman data can be maintained, even if the USB memory 12 is transferred to a third party such as the user. Furthermore, since the user data stored in the USB memory 12 cannot be opened and viewed by the serviceman, it is possible to prevent the content of user data from being viewed by the serviceman. Since the user data stored in the USB memory 12 cannot be opened and viewed by a third party, the secrecy of the user data can be maintained, even if the USB memory 12 is transferred to the third party.

Next, the serviceman connects the USB memory 12 to the image processing apparatus 10A, which is the object of maintenance. An acquisition unit of the image processing apparatus 10A acquires the updated or corrected serviceman data from the USB memory 12, and a decryption unit of the image processing apparatus 10A decrypts the acquired serviceman data. Then, an import unit of the image processing apparatus 10A performs data replacement processing to store the decrypted serviceman data into the data storage unit.

Next, the serviceman detaches the USB memory 12 from the image processing apparatus 10A which is the object of maintenance, and connects the USB memory 12 to the image processing apparatus 10B, as the object of management, to which user data such as address book should be set in accordance with the user's request. An acquisition unit of the image processing apparatus 10B acquires the user data from the USB memory 12, and a decryption unit decrypts the acquired user data. Then, an import unit of the image processing apparatus 10B stores the decrypted user data into a data storage unit, and makes settings such that new user data is applied.

The following is a description of the details of the image processing apparatuses described above.

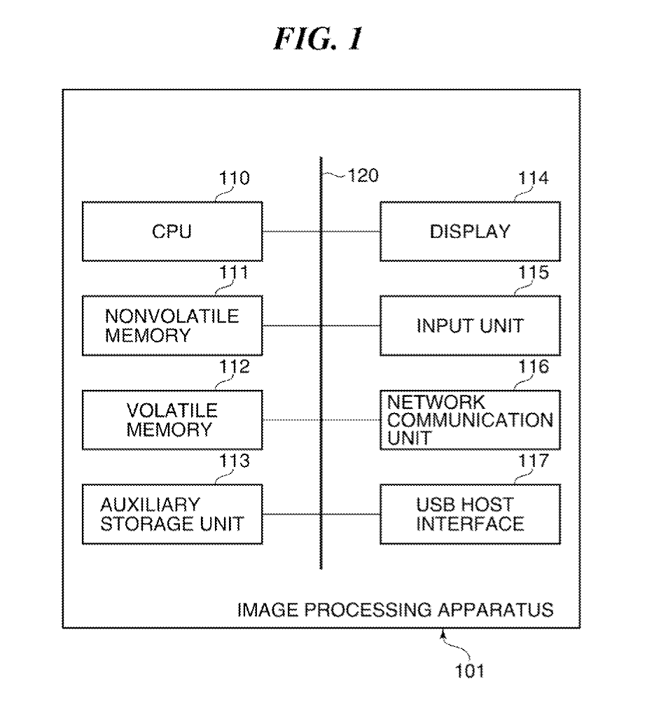

FIG. 1 shows in block diagram the hardware construction of each of the image processing apparatuses. In FIG. 1, reference numeral 101 denotes one image processing apparatus, which corresponds to the image processing apparatus 10A or 10B shown in FIG. 10.

The image processing apparatus 110 includes a CPU 110 that executes a program and controls various processes and further includes a nonvolatile memory 111, volatile memory 112, auxiliary storage unit 113, display 114, input unit 115, network communication unit 116, and USB host interface 117, which are connected to the CPU 110 through an internal bus 120.

The nonvolatile memory 111 is implemented by a ROM and stores a program and data necessary to start up the image processing apparatus 101. The volatile memory 112 is implemented by a RAM and used as a temporary storage of a program and data.

The auxiliary storage unit 113 is implemented by a large-capacity storage device such as a hard disk or a RAM drive, and stores large-capacity data and holds an execution code of a program. In the auxiliary storage unit 113, data to be held for a long time (e.g., user data and serviceman data) are stored. The display 114 displays information to the user and to the serviceman.

The input unit 115 accepts an instruction given from the user or from the serviceman. The network communication unit 116 communicates with an external information processing apparatus through a network. The USB host interface 117 is an interface for connection with a USB device such as the USB memory 12 shown in FIG. 10.

The image processing apparatus 101 can be constituted by a personal computer, a portable information terminal, other information device, or a computer peripheral device such as a printer, scanner, multifunction peripheral, or copy machine.

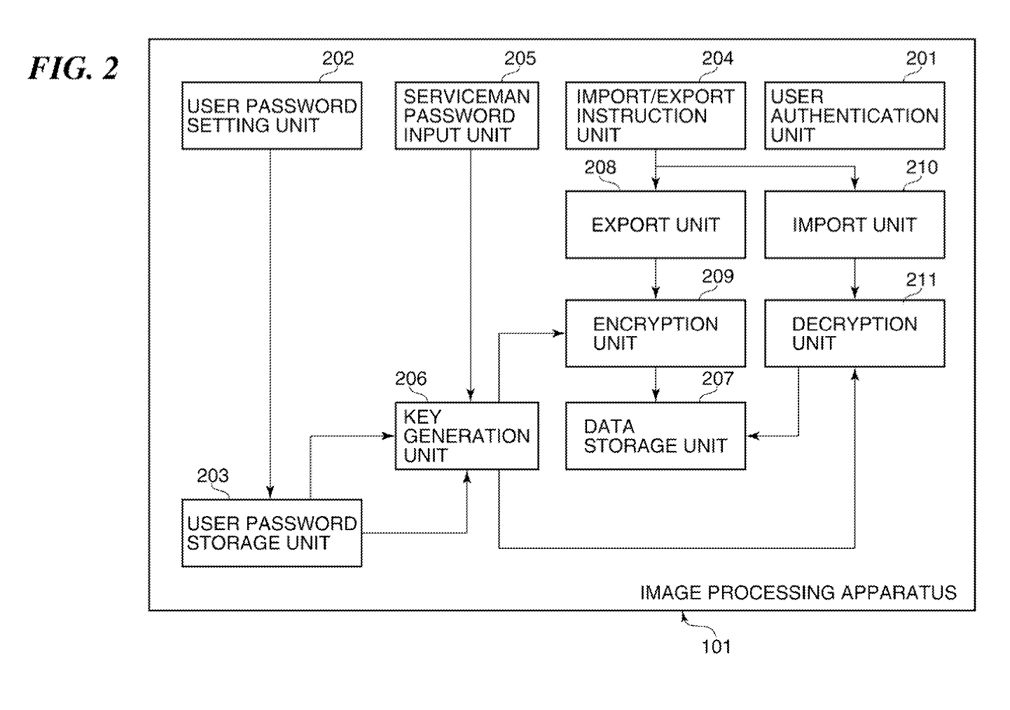

FIG. 2 shows in block diagram the software structure of the image processing apparatus 101.

As shown in FIG. 2, the image processing apparatus 101 includes a user authentication unit 201, user password setting unit 202, user password storage unit 203, import/export instruction unit 204, serviceman password input unit 205, key generation unit 206, data storage unit 207, export unit 208, encryption unit 209, import unit 210, and decryption unit 211.

The user authentication unit 201 performs authentication to identify whether a person who logs in the image processing apparatus 101 via the input unit 115 is an administrator user having the authority to manage the image processing apparatus 101 or a general user. The user authentication unit 201 also has a function of identifying whether or not the log-in person is a serviceman.

The user password setting unit 202 sets a user password that is input by a user via the input unit 115. The term “user password” refers to a password that is used for generation of an encryption key for encrypting user data, which is used for the data management operation. The image processing apparatus 101 must not have any means for allowing the serviceman to view the user password.

The user password storage unit 203 stores the user password set by the user password setting unit 202 into the auxiliary storage unit 113 in an encrypted and safety state.

The import/export instruction unit 204 provides an import instruction or an export instruction when the serviceman gives an instruction to import or export user data or serviceman data via the input unit 115.

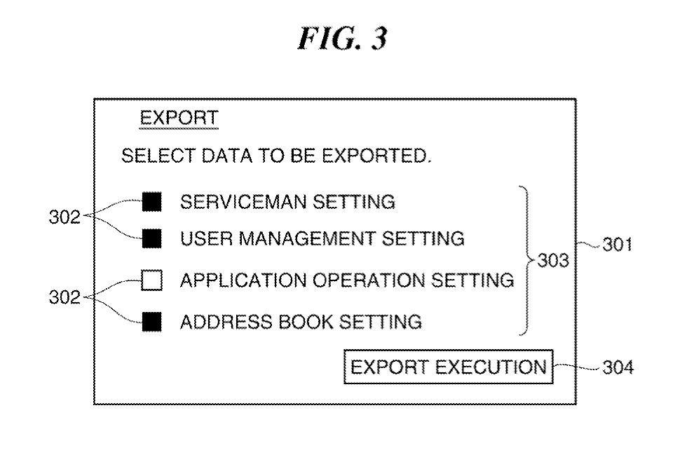

FIG. 3 shows an example of an export instruction screen displayed on the display 114 of the image processing apparatus 101. In FIG. 3, reference numeral 301 denotes the export instruction screen (serviceman-dedicated screen).

On the export instruction screen 301, there are displayed check boxes 302, export data candidates 303, and an export execution button 304. The export data candidates 303 are options/choices of data to be exported (hereinafter sometimes referred to as the export data). In the illustrated example, a serviceman setting, user management setting, application operation setting, and address book setting are displayed as the export data candidates 303. The check boxes 302 are selection means for selecting, from the export data candidates 303, export data which the serviceman wishes to export (i.e., the data to be exported). The export execution button 304 is used by the serviceman to give an instruction for exporting the selected export data.

On the export instruction screen 301, the serviceman can select the serviceman setting, user management setting, application operation setting, or address book setting, as export data, from the export data candidates 303 by checking a corresponding one of the check boxes 302, and can instruct export of the selected export data by pressing the export execution button 304.

When the export execution button 304 is pressed by the serviceman, the selected export data is subjected to export processing and stored into a USB memory (e.g., the USB memory 12 shown in FIG. 10).

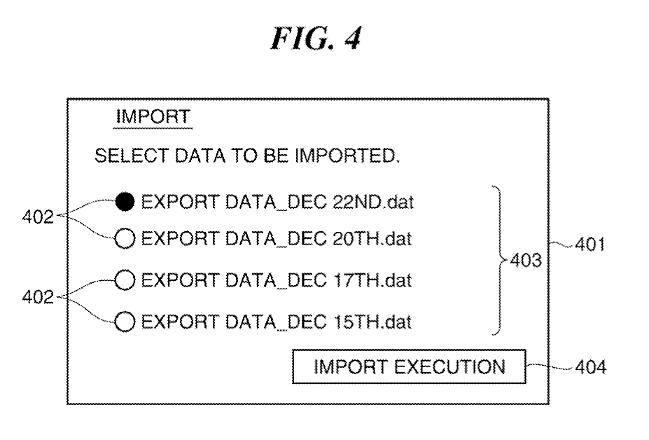

FIG. 4 shows an example of an import instruction screen displayed on the display 114 of the image processing apparatus 101. In FIG. 4, reference numeral 401 denotes the import instruction screen (serviceman-dedicated screen).

On the import instruction screen 401, there are displayed radio buttons 402, import data candidates 403, and an import execution button 404. The import data candidates 403 are options/choices of import object data that can be imported (hereinafter sometimes referred to as the import data). In the illustrated example, pieces of export data stored in a USB memory connected to the USB host interface 117 are displayed in a list, as the import data candidates 403, on the import instruction screen 401. The radio buttons 402 are selection means for selecting, from the import data candidate 403, import data which the serviceman wishes to import (i.e., import object data). In the illustrated example, a file having a file name “Export data_Dec 22nd.dat” is selected as the import data.

The import execution button 404 is used by the serviceman to give an instruction for importing the selected import data. When the import execution button 404 is pressed by the serviceman, the selected import data is subjected to import processing and stored into the image processing apparatus 101.

The serviceman password input unit 205 shown in FIG. 2 inputs a serviceman password input by the serviceman via the input unit 115. The term “serviceman password” refers to a password that is used for generation of an encryption key for encrypting serviceman data, which is used for the data management operation conducted by the serviceman.

In the image processing apparatus 101 shown in FIG. 2, the serviceman password must be input via the serviceman password input unit 205 (input unit 115 shown in FIG. 1) at each execution of import and at each execution of export.

The key generation unit 206 shown in FIG. 2 generates encryption and decryption keys from a character string of the user password stored in the user password storage unit 203, and generates encryption and decryption keys from a character string of the serviceman password input via the serviceman password input unit 205. It should be noted that the key generation unit 206 fails to generate the keys, if no user password is stored in the user password storage unit 203.

The data storage unit 207 shown in FIG. 2 is configured to be capable of storing user data and service data into the auxiliary storage unit 113 shown in FIG. 1 and capable of storing a list of user data and service data (hereinafter referred to as the data list).

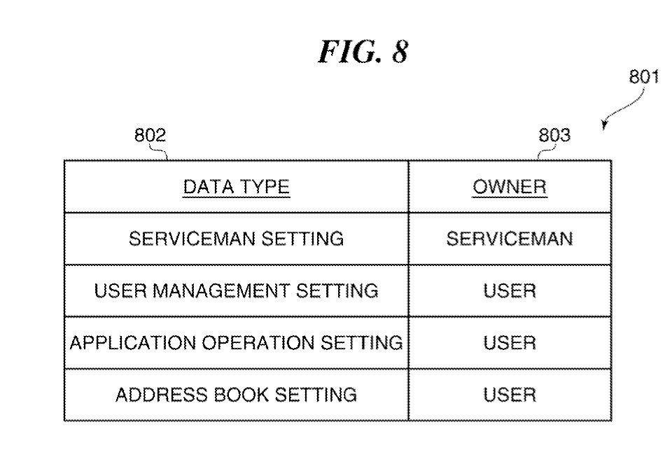

FIG. 8 shows an example of the data list stored in the data storage unit 207. In FIG. 8, reference numeral 801 denotes the data list.

As shown in FIG. 8, the data list 801 includes a data type field 802 and an owner field 803. In the data type field 802, there are stored pieces of information representing types of data held in the data storage unit 207. In the illustrated example, the data types are a serviceman setting, user management setting, application operation setting, and address book setting.

In the owner field 803, there are stored pieces of information representing owners (user or serviceman) of respective data indicated in the data type field 802. If information in the owner field 803 represents the user, the corresponding data type is user data. If information in the owner field 803 represents the serviceman, the corresponding data type is serviceman data. In the illustrated example, the serviceman setting is comprised of data owned by the serviceman, and the user management setting, application operation setting, and address book setting are each comprised of data owned by the user.

In accordance with an instruction given by the import/export instruction unit 204, the export unit 208 shown in FIG. 2 performs export processing. More specifically, the export unit 208 generates export data based on information delivered from the import/export instruction unit 204 and representing the export data selected from the export data candidates 303 on the export instruction screen 301 shown in FIG. 3. The export data generated by the export unit 208 is encrypted by the encryption unit 209 and then stored into a USB memory connected to the USB host interface 117.

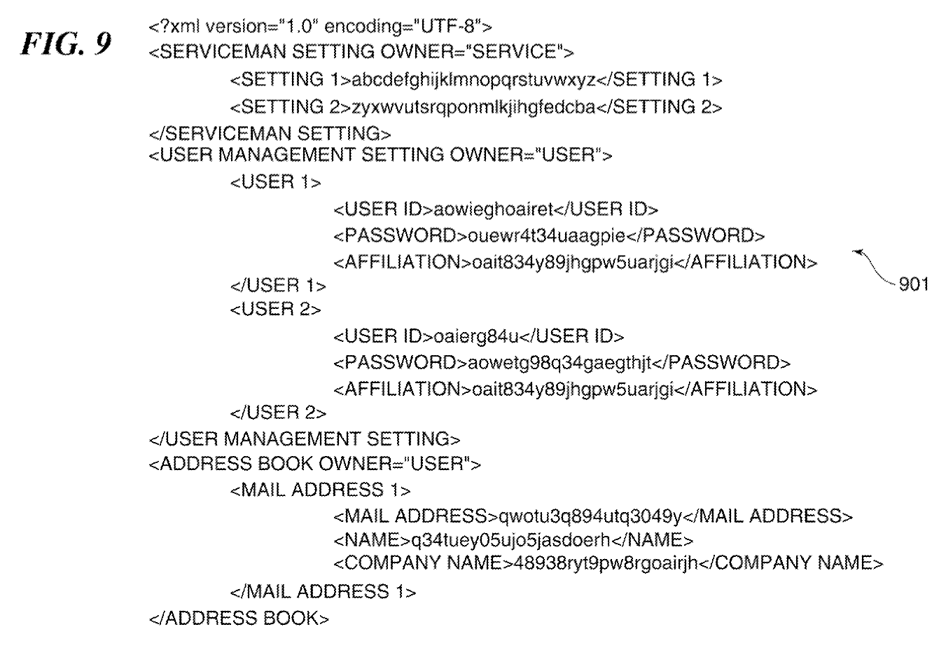

FIG. 9 shows an example of the export data generated by the export unit 208. In FIG. 9, reference numeral 901 denotes the export data.

In the export data 901, there is at least one tag corresponding to at least one of the export data candidates 303 shown in FIG. 3. In the illustrated example, there are three tags (element names), i.e., a “Serviceman setting” tag, a “User management setting” tag, and an “Address book” tag. Each tag has at least one attribute (attribute name), which is sometimes followed by an attribute value that indicates the owner of data relating to the tag. For example, an attribute value “Service” following an attribute name “Owner” of the “Serviceman setting” tag represents that the serviceman is the owner of data relating to the “Serviceman setting” tag. In some cases, the attribute of a tag is represented by one or more subtags. For example, the “Serviceman setting” tag has a “Setting 1” subtag and a “Setting 2” subtag. Since the export data 901 is encrypted by the encryption unit 209, there is no fear of leakage.

The encryption unit 209 encrypts user data and serviceman data with encryption keys generated by the key generation unit 206. For example, the encryption unit 209 discriminates between user data and serviceman data in the export data 901 with reference to the data list 801 stored in the data storage unit 207 or the attribute (owner information) of each tag in the export data 901, encrypts the user data with the encryption key generated by the key generation unit 206 from the user password, and encrypts the serviceman data with the encryption key generated by the key generation unit 206 from the serviceman password.

In accordance with an instruction given by the import/export instruction unit 204, the import unit 210 shown in FIG. 2 performs import processing. More specifically, the import unit 210 acquires import data from a USB memory connected to the USB host interface 117 based on information delivered from the import/export instruction unit 204 and representing the import data selected from import data candidates 403 on the import instruction screen 401. The import data acquired by the import unit 210 is decrypted by the decryption unit 211 and then stored into the data storage unit 207.

The decryption unit 211 decrypts user data and serviceman data with decryption keys generated by the key generation unit 206. For example, the decryption unit 211 discriminates between user data and serviceman data in the import data based on, e.g., the attribute (owner information) indicated in each tag of the import data, decrypts the user data with the decryption key generated by the key generation unit 206 from the user password, and decrypts the serviceman data with the decryption key generated by the key generation unit 206 from the serviceman password.

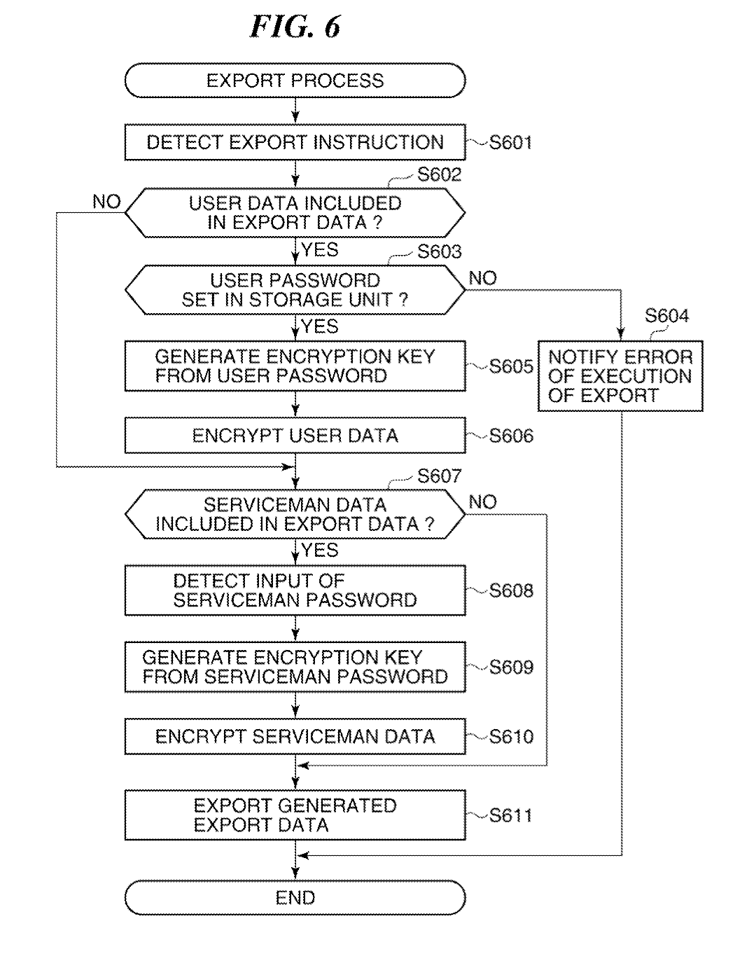

FIG. 6 shows, in flowchart, procedures of an export process performed by the image processing apparatus 101. It should be noted that the export process is performed by the CPU 110 by reading and executing an execution code of a program stored in the storage unit (i.e., any of the nonvolatile memory 111, the volatile memory 112, and the auxiliary storage unit 113).

In the export process shown in FIG. 6, when the user operates the input unit 115 to input an export instruction, the input unit 115 notifies the import/export instruction unit 204 of receipt of the export instruction. In response to the notification, the import/export instruction unit 204 detects the export instruction and notifies the export unit 208 of the export instruction (step S601).

Based on the notified export instruction, the export unit 208 determines whether or not export data to be exported (hereinafter referred to as the export data) includes user data (step S602). The process proceeds to step S603, if the export data includes user data (i.e., if YES to step S602), but proceeds to step S607, if the export data does not include user data (i.e., if NO to step S602).

In step S603, the key generation unit 206 determines whether or not a user password has been set in the user password storage unit 203. The process proceeds to step S604, if no user password has been set in the storage unit 203, but proceeds to step S605, if a user password has been set in the storage unit 203.

In step S604, the import/export instruction unit 204 notifies the serviceman that execution of export has failed and no user password has been set, whereupon the export process is completed.

In step S605, the key generation unit 206 generates an encryption key based on the user password stored in the user password storage unit 203, and transmits the generated encryption key to the encryption unit 209. The encryption unit 209 encrypts the user data with the received encryption key, and transmits the encrypted user data to the export unit 208 (step S606).

Next, the export unit 208 receives data to be exported that includes the user data generated and encrypted in step S606, or receives data to be exported and the result of the determination in step S602 to the effect that the data to be exported does not include user data. Then, the export unit 208 determines whether or not export data for which the export instruction has been given by the import/export instruction unit 204 includes serviceman data (step S607). The process proceeds to step S608, if the export data includes serviceman data (i.e., if YES to step S607), but proceeds to step S611, if the export data does not include serviceman data (i.e., if NO to step S607).

In step S608, the serviceman password input unit 205 displays a screen for prompting input of a serviceman password, and then detects a serviceman password being input. The key generation unit 206 generates an encryption key based on the input serviceman password and transmits the generated encryption key to the encryption unit 209 (step S609). The encryption unit 209 encrypts the serviceman data with the received encryption key and transmits the encrypted serviceman data to the export unit 208 (step S610).

The export unit 208 generates export data based on data to be exported and exports the generated export data (step S611). More specifically, when receiving the user data and serviceman data both of which have been encrypted by the encryption unit 209 (i.e., if YES to step S602 and YES to step S607), the export unit 208 generates export data including the encrypted user data and the encrypted serviceman data. When receiving either the encrypted user data or the encrypted serviceman data (i.e., if NO to step S602 and YES to step S607 or if YES to step S602 and NO to step S607), the export unit 208 generates export data only including the encrypted user data or the encrypted serviceman data. When receiving neither the encrypted user data nor the encrypted serviceman data (i.e., if NO to step S602 and NO to step S607), the export unit 208 generates export data including neither the user data nor the serviceman data.

Then, the export unit 208 stores the export data generated as described above into a USB memory connected to the USB host interface 117, and completes the export process.

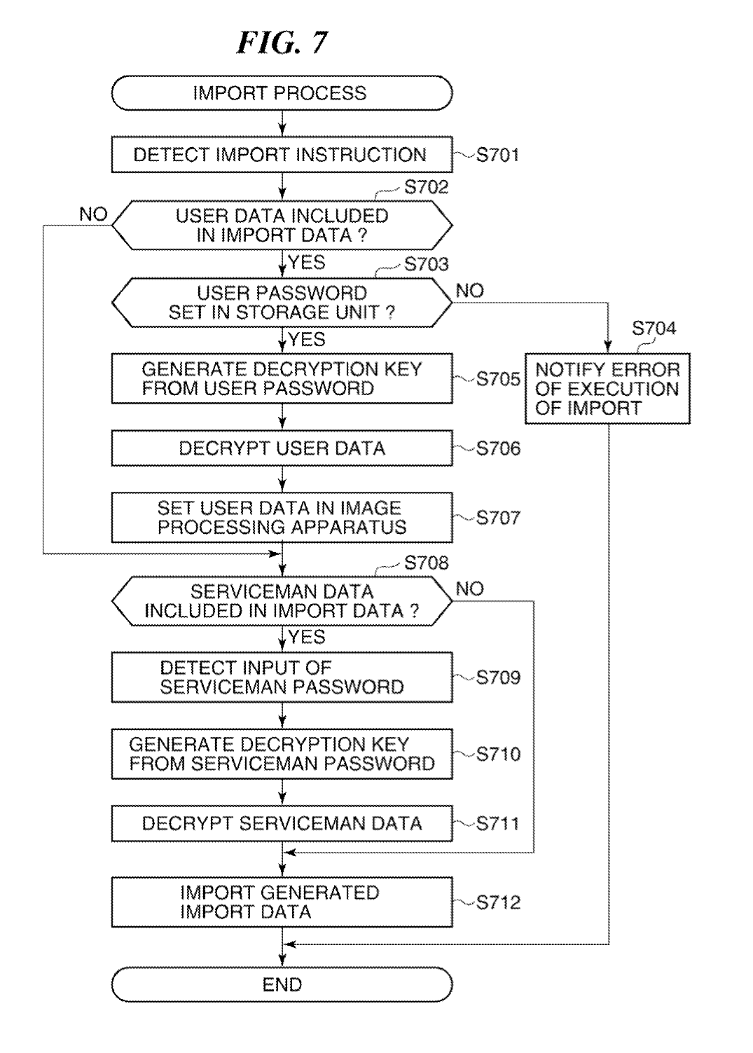

FIG. 7 shows, in flowchart, procedures of an import process performed by the image processing apparatus 101. It should be noted that the import process is performed by the CPU 110 by reading and executing an execution code of a program stored in the storage unit (i.e., any of the nonvolatile memory 111, the volatile memory 112, and the auxiliary storage unit 113).

In the import process shown in FIG. 7, when the user operates the input unit 115 to input an import instruction, the input unit 115 notifies the import/export instruction unit 204 of receipt of the import instruction. In response to the notification, the import/export instruction unit 204 detects the import instruction and notifies the import unit 210 of the import instruction (step S701).

Based on the notified import instruction, the import unit 210 acquires data to be imported (hereinafter referred to as the import data) from a USB memory connected to the USB host interface 117. Then, the import unit 210 analyzes the acquired import data and determines whether or not the import data includes user data (step S702). The process proceeds to step S703, if the import data includes user data (i.e., if YES to step S702), but proceeds to step S708, if the import data does not include user data (i.e., if NO to step S702).

In step S703, the key generation unit 206 determines whether or not a user password has been set in the user password storage unit 203. The process proceeds to step S704, if no user password has been set in the storage unit 203 (i.e., if NO to step S703), but proceeds to step S705 if a user password has been set in the storage unit 203 (i.e., if YES to step S703).

In step S704, the import/export instruction unit 204 notifies the serviceman that execution of import has failed and no user password has been set, whereupon the import process is completed.

In step S705, the key generation unit 206 generates a decryption key based on the user password stored in the user password storage unit 203 and transmits the generated decryption key to the decryption unit 211. The decryption unit 211 decrypts the user data with the received decryption key, transmits the decrypted user data to the import unit 210 (step S706), and stores the decrypted user data into the data storage unit 207(step S707).

The import unit 210 receives data to be imported that includes the user data decrypted in step S706, or receives data to be imported and the result of the determination in step S702 to the effect that the data to be imported does not include user data. Then, the import unit 210 determines whether or not the import data for which the import instruction has been given by the import/export instruction unit 204 includes serviceman data (step S708). The process proceeds to step S709, if the import data includes serviceman data (i.e., if YES to step S708), but process proceeds to step S712, if the import data does not include serviceman data (i.e., if NO to step S708).

In step S709, the serviceman password input unit 205 displays a screen for prompting input of a serviceman password, and then detects a serviceman password being input. The key generation unit 206 generates a decryption key based on the input serviceman password and transmits the generated decryption key to the decryption unit 211 (step S710). The decryption unit 211 decrypts the serviceman data with the received decryption key and transmits the decrypted serviceman data to the import unit 210 (step S711).

The import unit 210 generates import data based on data to be imported and imports the generated import data (step S712). More specifically, when receiving the user data and serviceman data both of which have been decrypted by the decryption unit 211 (i.e., if YES to step S702 and YES to step S708), the import unit 210 stores data including the decrypted user data and the decrypted serviceman data into the data storage unit 207. When receiving either the decrypted user data or the decrypted serviceman data (i.e., if NO to step S702 and YES to step S708 or if YES to step S702 and NO to step S708), the import unit 210 stores data only including the decrypted user data or the decrypted serviceman data into the data storage unit 207. When receiving neither the decrypted user data nor the decrypted serviceman data (i.e., if NO to step S702 and NO to step S708), the import unit 210 stores data including neither the user data nor the serviceman data into the data storage unit 207. Whereupon, the import process is completed.

In the following, a description will be given of modifications of various parts of the image processing apparatus.

The image processing apparatus 101 of the above-described embodiment is configured to import and export data from and to a USB memory connected to the USB host interface 117, but this is not limitative. For example, the image processing apparatus can be configured to perform HTTP communication with an external information processing apparatus via the network communication unit 116. In that case, the import instruction and the export instruction are given from a web browser of the external information processing apparatus, and import data and export data are stored into a storage unit of the external information processing apparatus.

Alternatively, the external information processing can be configured to give the import instruction and the export instruction in SOAP message. In that case, the external information processing transmits a SOAP message representing an import instruction or an export instruction by using an application function, and the image processing apparatus receives the SOAP message via the network communication unit 116.

In the embodiment, the import process of FIG. 7 is completed with an error, if it is determined that no user password is stored in the storage unit 203, but this is not limitative. For example, only serviceman data can be imported and user data can be imported later when it is determined that no user password is stored in the storage unit 203.

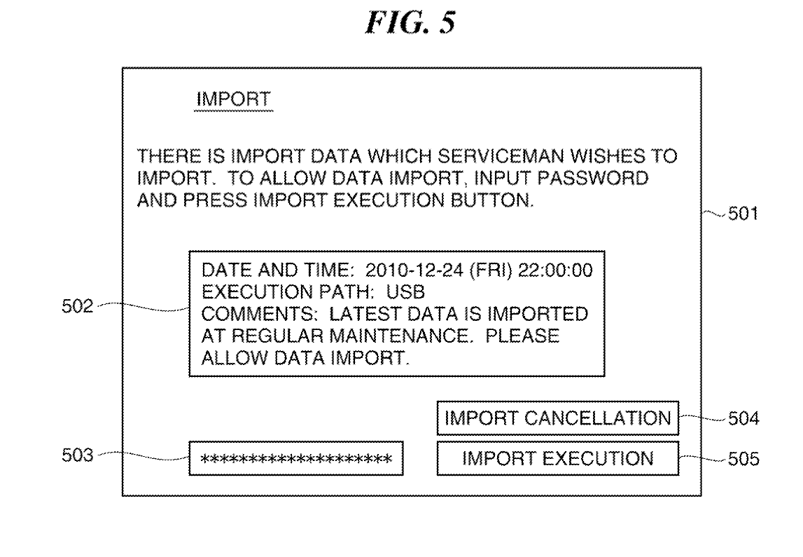

With this modification, when the administrator user is authenticated for the first time by the user authentication unit 201, a layaway import screen 501 exemplarily shown in FIG. 5 is displayed on the display of the image processing apparatus. On the layaway import screen 501, there are displayed an import details information field 502, password input field 503, import reject button 504, and import execution button 505.

The import details information field 502 is a field in which there are displayed data and time of import instruction, execution path, and serviceman comments, for example. The password input field 503 is a field into which a user password is input. The import reject button 504 is a button to reject the execution of the import process. When the import reject button 504 is pressed, user data is not imported but deleted. The import execution button 505 is a button to execute the import process.

The CPU of an image processing apparatus of this modification decrypts user data with a decryption key generated by the key generation unit based on a user password input to the password input field 503, and performs the import process.

In the above-described embodiment, the user password setting unit 202 of the image processing apparatus 101 is configured to set a user password input by a user via the input unit 115, but this is not limitative. For example, the user password setting unit 202 can input a user password from a web browser of an external information processing apparatus via the network communication unit 116.

In the embodiment, the user password storage unit 203 is configured to store the user password set by the user password setting unit 202 into the auxiliary storage unit 113 in an encrypted state, but this is not limitative. For example, the user password storage unit 203 can encrypt intermediate data (such as a hashed user password) obtained during key generation processing performed by the key generation unit 206 and can store the encrypted intermediate data into the auxiliary storage unit 113. In a case that the auxiliary storage unit 113 is high in security, the user password storage unit 203 can store the user password into the auxiliary storage unit 113 without encrypting the user password.

In the export process shown in FIG. 6 and in the import process shown in FIG. 7, user data is first processed and then serviceman data is processed, but this is not limitative. For example, the serviceman data can be first processed and then the user data can be processed. Alternatively, these data can be processed in a specified order of data type.

In the embodiment, the export data 901 shown in FIG. 9 is configured that the attributes of tags each representing data type have owner information (attribute values), and the owner of each data is determined based on the owner information. However, it is not indispensable for the attributes of tags to have owner information. For example, the owner of data can be determined based on data types shown in tags of the export data 901 with reference to the data list 801 shown in FIG. 8.

The export data 901 is configured that encrypted data is embedded into tags and subtags, but this is not limitative. For example, information included in subtags of a tag representing data type (e.g., the “User 1” subtag and the “User 2” subtag of the “User management setting” tag) can be encrypted into a character string, and the encrypted information can be set into the tag (e.g., the “User management setting” tag).

The personal computer 11 shown in FIG. 10 can be configured to be capable of performing the same processing (such as encryption and decryption of serviceman data) as that conducted by the image processing apparatus 101, thereby achieving the same functions and effects as those attained by the image processing apparatus 101.

### Other Embodiments

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2011-103711, filed May 6, 2011, which is hereby incorporated by reference herein in its entirety.

What is claimed is:

1. An information processing apparatus comprising:
a storage unit configured to store user data peculiar to a user of the information processing apparatus and to store serviceman data for use by a serviceman in conducting maintenance of the information processing apparatus;
an encryption unit configured to encrypt the user data with an encryption key generated based on information set in advance in the information processing apparatus and configured to encrypt the serviceman data with an encryption key generated based on information input by the serviceman; and
an output unit configured to output the user data and the serviceman data both encrypted by said encryption unit.

2. The information processing apparatus according to claim 1, further including:
an acquisition unit configured to acquire encrypted user data and encrypted serviceman data from an external apparatus; and
a decryption unit configured to decrypt the encrypted user data with a decryption key generated based on the information set in advance in the image processing apparatus and configured to decrypt the encrypted serviceman data with a decryption key generated based on the information input by the serviceman,
wherein said storage unit stores the user data and the serviceman data both decrypted by said decryption unit.

3. The information processing apparatus according to claim 1, wherein the information stored in advance in the image processing apparatus is a user password, and the information input by the serviceman is a serviceman password.

4. The information processing apparatus according to claim 1, further comprising:
a determination unit configured to determine whether or not the information for use in generating the encryption key for encrypting the user data is set in the information processing apparatus,
wherein said output unit is prohibited from outputting the user data in a case where it is determined by said determination unit that the information is not set in the information processing apparatus.

5. The information processing apparatus according to claim 1, wherein said output unit outputs the user data and the serviceman data both encrypted by said encryption unit to a removable medium connected to the information processing apparatus.

6. The information processing apparatus according to claim 1, wherein the user data is an address book.

7. A data management method for an information processing apparatus, comprising:
a storage step of storing user data peculiar to a user of the information processing apparatus and storing serviceman data for use by a serviceman in conducting maintenance of the information processing apparatus;
an encryption step of encrypting the user data with an encryption key generated based on information set in advance in the information processing apparatus and encrypting the serviceman data with an encryption key generated based on information input by the serviceman; and
an output step of outputting the user data and the serviceman data both encrypted in said encryption step.

8. A non-transitory computer readable storage medium storing a program for causing a computer to execute the data management method as set forth in claim 7.
